(19) United States
(12) Patent Application Publication
(10) Pub. No.: US 2008/0256585 A1
(43) Pub. Date: Oct. 16, 2008

(54) System for broadcasting multimedia data

(75) Inventor: Lei He, Nanking City (CN)

Correspondence Address: BIRCH STEWART KOLASCH & BIRCH, PO BOX 747, FALLS CHURCH, VA, 22040-0747, US

(73) Assignee: Inventec Appliances Corp.

(21) Appl. No.: 12/081,081

(22) Filed: Apr. 10, 2008

(30) Foreign Application Priority Data
Apr. 13, 2007 (TW) 96113140

(51) Int. Cl. H04N 7/173

(52) U.S. Cl. 725/116

(57) ABSTRACT

A system for broadcasting multimedia data is provided for improving an on-site feeling and comprises: a multimedia data supplier, which divides a multimedia datum into a plurality of packets for output, wherein the packet at least comprises a multimedia signal and a specific signal; a set-top box, which has a receiver, a first output and a second output, the receiver is connected to the multimedia data supplier for receiving the packets, the packets are transferred to the multimedia signal and the specific signal after the set-top box decoding the packets, the multimedia signal is output by the first output and the specific signal is output by the second output; a multimedia broadcasting device, which is connected to the first output and broadcasts the multimedia signal; and a specific executing device, which is connected to the second output and executes the specific defined by the specific signal.

### BACKGROUND OF THE INVENTION

1. Field of the Invention

The present invention generally relates to a system for broadcasting multimedia data, more particular to a system producing special effects according to the multimedia data.

2. Description of the Prior Art

With the advances and differences of science, new technologies have being brought to human being life with new senses for entertainment while the new technologies have being applied to industry. As an example, following digital camera, mobile phone, digital TV, home theater gradually became an issue to consumer electronic products, and nowadays it is the most popular entertainment product in our lives. Home theater is a system for broadcasting multimedia data and combine highly restored sound and images so as to provide better entertainment effects.

There are several kinds of displays as CRT, LCD, ion display, etc. with big screens and high resolutions to display images. In sound aspect, a surround stereophony with the system of Dolby AC-3 may highly increase an on-site feeling as well. The application of the multimedia broadcast is widely brought into play, and it is more important in the aspect of entertainment. So that, a system for broadcasting the multimedia data is definitely close to the multimedia broadcast. And the combination of both makes the development of entertainment step further. Therefore, the market for such combination will be unlimited. The system may have a set-top box, which functions will be that of receiving digital signals, decoding and displaying decoded signals on a screen.

With reference to FIG. 1a, which illustrates a schematic view of a prior system for broadcasting multimedia data. The system includes a multimedia data supplier 110, a set-top box 120 and a multimedia broadcasting device 130.

The multimedia data supplier 110 divides a multimedia datum into a plurality of packets 114 for output, wherein each packet 114 at least comprises a multimedia signal 124; the set-top box 120 has a receiver 121, a processor 121′ and an output 122, the receiver 121 is connected to the multimedia data supplier 110 for receiving the plurality of packets 114, the packets 114 are transferred to the multimedia signal 124 after the set-top box 120 decoding the packets 114, the multimedia signal 124 is output by the output 122.

The multimedia data supplier 110 comprises a wireless transmission system 111, a cable transmission system 112 and a content server 113. The wireless transmission system 111 can be a satellite broadcasting system, a ground broadcasting system, etc. The cable transmission system 112 can be an internet, an access network, which is the assembly of PSTN and ADSL or a cable television network and a cable modem. The content server 113 stores program contents with the format of transport stream (TS).

The multimedia data comprise the group of video, audio, service information, and the specific signal or any of the group. Any of the packets comprises a packet ID (PID), the packet ID comprises a program association table (PAT) 150, the program association table 150 comprises a program map table (PMT) 160.

While an audience or audiences are watching a program through a prior system 100 for broadcasting multimedia data, the multimedia data supplier 110 provides the multimedia datum, then the multimedia datum is divided into the plurality of packets 114, which are output to the set-top box 120. With reference to FIG. 1b, which illustrates a schematic relationship of the PAT and PMT of a prior system for broadcasting multimedia data. The processor 121′ of the set-top box 120 decodes the packets 114, and the PAT 150 is searched in the code stream. The PMT 160 of the specific program is then searched in the PAT 150. The content of the multimedia data are sorted according to the value of the PID of the PMT 160. The content can be a video signal as a code stream 1 and an audio signal as a code stream 2. The multimedia signal 124 is categorized and delivered to the multimedia broadcasting device 130 via the output 122 of the set-top box 120. Since the prior system generates its own limited way, the audience or audiences are limited in the aspect of on-site feeling as well.

According to the disadvantage of the prior art, in order to highly increase the feelings to on-site and 3-dimension to an audience or audiences, how to improve the technology is an important issue for the skilled people in the art.

### SUMMARY OF THE INVENTION

The present invention is to provide a system for broadcasting multimedia data. Through the system, the feelings to on-site and 3-dimension will be highly increased so as to make an audience or audiences be enjoyable.

The present invention provides the system for broadcasting multimedia data comprises a multimedia data supplier, a set-top box, a multimedia broadcasting device, and a specific executing device.

The multimedia data supplier divides a multimedia datum into a plurality of packets for output, wherein the packets at least comprise a multimedia signal and a specific signal; the set-top box has a receiver, a processor, a first output, and a second output, the receiver is connected to the multimedia data supplier for receiving the plurality of packets, the packets are transferred to the multimedia signal and the specific signal after the processor of the set-top box decoding the packets, the multimedia signal is output by the first output and the specific signal is output by the second output; the multimedia broadcasting device, which is connected to the first output and broadcasts the multimedia signal; and the specific executing device, which is connected to the second output and executes the specific defined by the specific signal.

Wherein the multimedia data supplier comprises a wireless transmission system, a cable transmission system and a content server. The wireless transmission system can be a satellite broadcasting system, a ground broadcasting system, etc. The cable transmission system can be an internet, an access network, which is the assembly of PSTN and ADSL or a cable television network and a cable modem. The content server can be the content server of a business body or a PC. The multimedia data comprise the group of video, audio, service information, and the specific signal or any of the group. The specific executing device comprises the group of a sound generator, a light generator, a fluid spray generator, a mechanism-action generator, and a scent generator, or any of the group. Any of the packets comprises a packet ID (PID), the packet ID comprises a program association table (PAT), the program association table comprises a program map table (PMT).

While a specific program is being broadcasted by a broadcasting system with traditional multimedia data, the multimedia data supplier provides a multimedia datum, which comprises at least one multimedia signal and a specific signal, the traditional packets are output to the set-top box, the processor of the set-top box decodes the packets and searches the program association table (PAT) in the code stream of the specific program and the program map table (PMT) of the specific program in the program association program (PAT). After comparing the packet ID (PID) of the specific program of the program association table with the content of the multimedia data, the multimedia data are then categorized, such as video signal, audio signal, specific signal, etc. The output of the set-top box continuously transits the multimedia signals and the specific signal to the multimedia broadcasting device and the specific executing device.

Through the system, not only the audience or audiences viewing the images from the multimedia broadcasting device, but also the specific effects from the specific executing device, the feelings to on-site and 3-dimension will be highly increased so as to make an audience or audiences be enjoyable.

With the comparison to the prior system for broadcasting multimedia data, the present invention obviously increases the feelings to entertainment and space.

Other and further features, advantages and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

The objects, spirits, and advantages of the preferred embodiments of the present invention will be readily understood by the accompanying drawings and detailed descriptions, wherein:

FIG. 1a illustrates a schematic view of a prior system for broadcasting multimedia data;

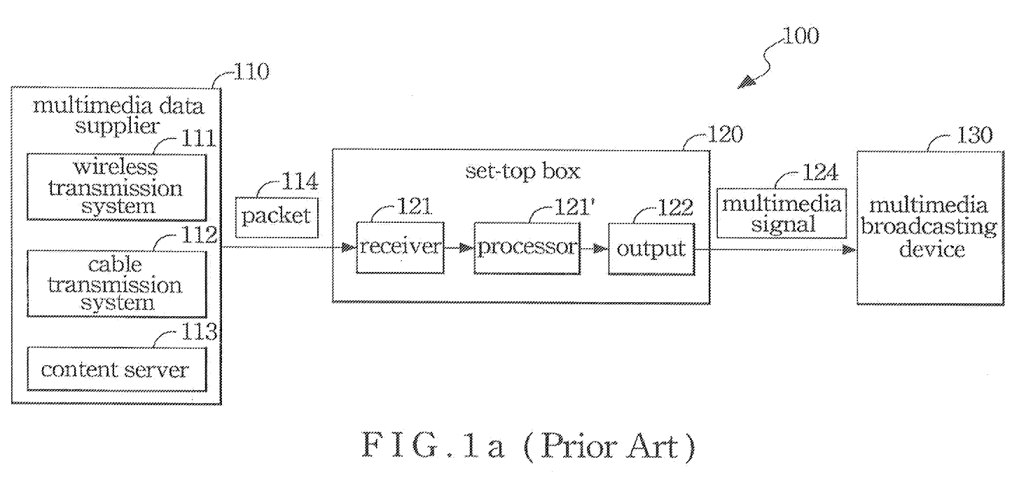

FIG. 1b illustrates a schematic relationship of a PAT and a PMT of a prior system for broadcasting multimedia data;

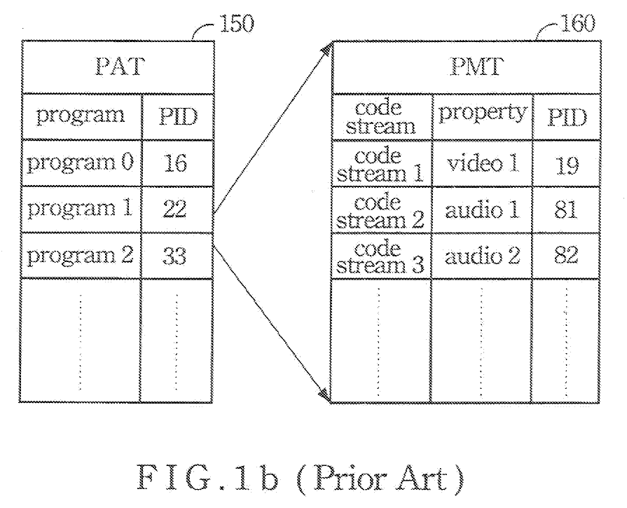

FIG. 2a illustrates a schematic view of the system for broadcasting multimedia data of the present invention; and

FIG. 2b illustrates a schematic relationship of a PAT and a of the system of the present invention; and

FIG. 3 illustrates a flow chart of the method of the present invention.

### DETAILED DESCRIPTION OF THE INVENTION

The present invention discloses a system for broadcasting multimedia data. Through the system, the feelings to on-site and 3-dimension will be highly increased so as to make an audience or audiences be enjoyable. The technical part of the present invention will be described in detail as below.

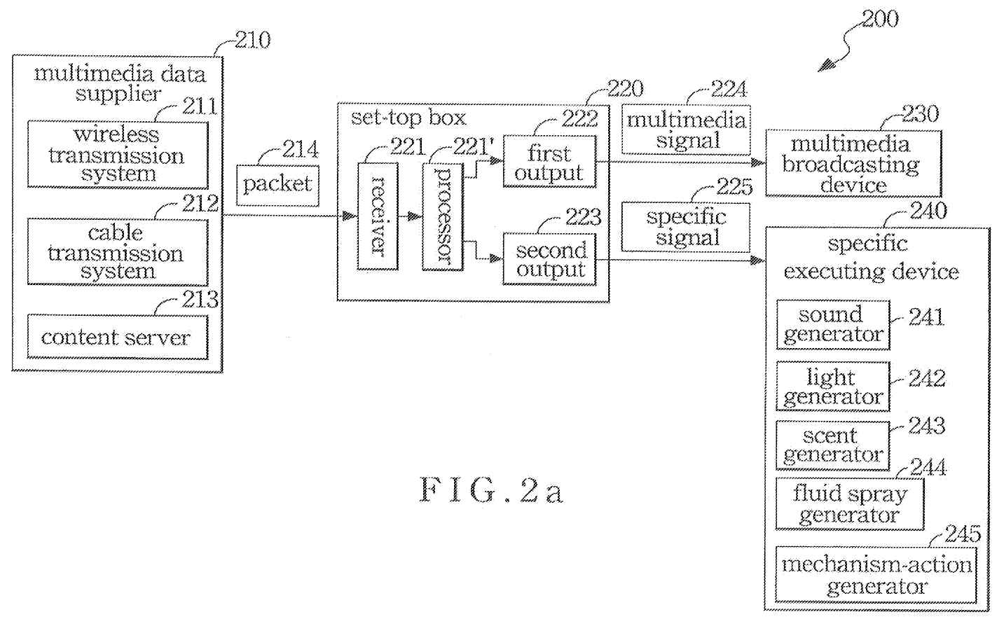

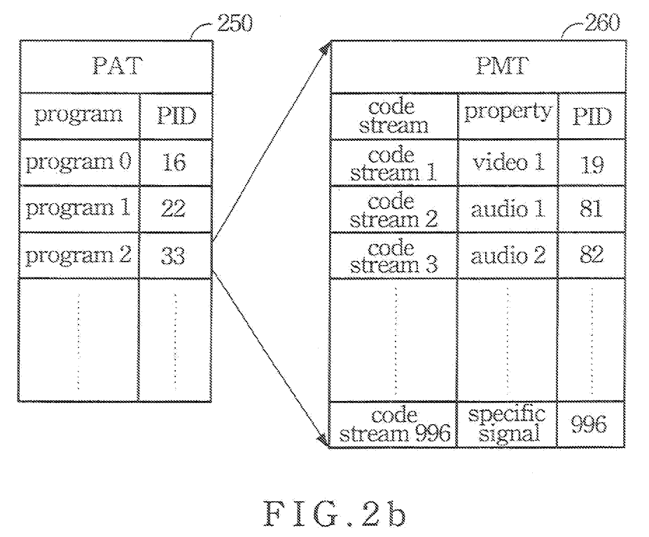

With reference to FIG. 2a, which illustrates a schematic view of the system for broadcasting multimedia data of the present invention. The system includes a multimedia data supplier 210, a set-top box 220, a multimedia broadcasting device 230, and a specific executing device 240.

The multimedia data supplier 210 divides a multimedia datum into a plurality of packets 214 for output, wherein the packets 214 at least include a multimedia signal 224 and a specific signal 225. The specific signal 225 is added into the multimedia datum according to a certain standard at the end of producing the multimedia data. The set-top box as a gateway has a receiver 221, a processor 221′, a first output 222, and a second output 223, the receiver 221 is connected to the multimedia data supplier 210 for receiving the packets 214, the packets 214 are transferred to the multimedia signal 224 and the specific signal 225 after the set-top box 220 decoding the packets, the multimedia signal 224 is output by the first output 222 and the specific signal 225 is output by the second output 223. The multimedia broadcasting device 230 is connected to the first output 222 and broadcasts the multimedia signal 224. The specific executing device 240 is connected to the second output 223 and executes the specific defined by the specific signal 225.

The multimedia data supplier 210 includes a wireless transmission system 211, a cable transmission system 212 and a content server 213. The wireless transmission system 211 can be a satellite broadcasting system, a ground broadcasting system, etc. The cable transmission system 212 can be an internet, an access network, which is the assembly of PSTN and ADSL or a cable television network and a cable modem. The content server 213 can be the content server of a business body or a PC. The format of a packet may be different than others due to different transporting ways, but every one of them provides a code stream including the multimedia signal 224 and the specific signal 225, and the code stream is the format of transport stream (TS).

The multimedia data comprise the group of video, audio, service information, and the specific signal or any of the group. The specific executing device 240 includes the group of a sound generator 241, a light generator 242, a fluid spray generator 244, a mechanism-action generator 245, and a scent generator 243, or any of the group, so that the specific may have the effect group of sound, light, fluid spray, mechanism-action, and scent or any of the effect group. Any of the packets comprises a packet ID (PID), the packet ID comprises a program association table (PAT) 250, the program association table 250 comprises a program map table (PMT) 260.

While an audience or audiences are watching a program through a prior system 200 for broadcasting multimedia data, the multimedia data supplier 210 provides the multimedia datum, then the multimedia datum is divided into the plurality of packets 214, which are output to the set-top box 220. With reference to FIG. 2b, which illustrates a schematic relationship of the PAT and PMT of the system of the present invention. The processor 221′ of the set-top box 220 decodes the packets 214, and the PAT 250 is searched in the code stream. The PMT 260 of the specific program is then searched in the PAT 250. The content of the multimedia data are sorted according to the value of the PID of the PMT 260. The content can be a video signal as a code stream 1, an audio signal as a code stream 2 and a specific signal 225 as a code stream 996. The multimedia signal 224 as the video signal and audio signal and the specific signal 225 are categorized and delivered to the multimedia roadcasting device 230 and the specific executing device 240 via the output 222 of the set-top box 220.

Not only the images from the multimedia broadcasting device 230 are output to the audience or audiences, but also the specifics from the specific executing device 240. Such specifics comprises different luminosities of light and the actions of air-spray, water-spray, rotation, vibration, going up and down, tightness, partially knocking, etc. For instance, while the audience or audiences are watching program, which scenario is that a star is in a jungle at a wet and windy night, then the specific executing device 240 broadcasts the specifics of flash light, sound from brushwood, thunder, sound from animals, eventually the leg of the star being clasped by vines, etc. Such that, the relative portion of the specific executing device 240 will tighten the legs of the audiences in order to let the audiences physically feel the reality from the scenario.

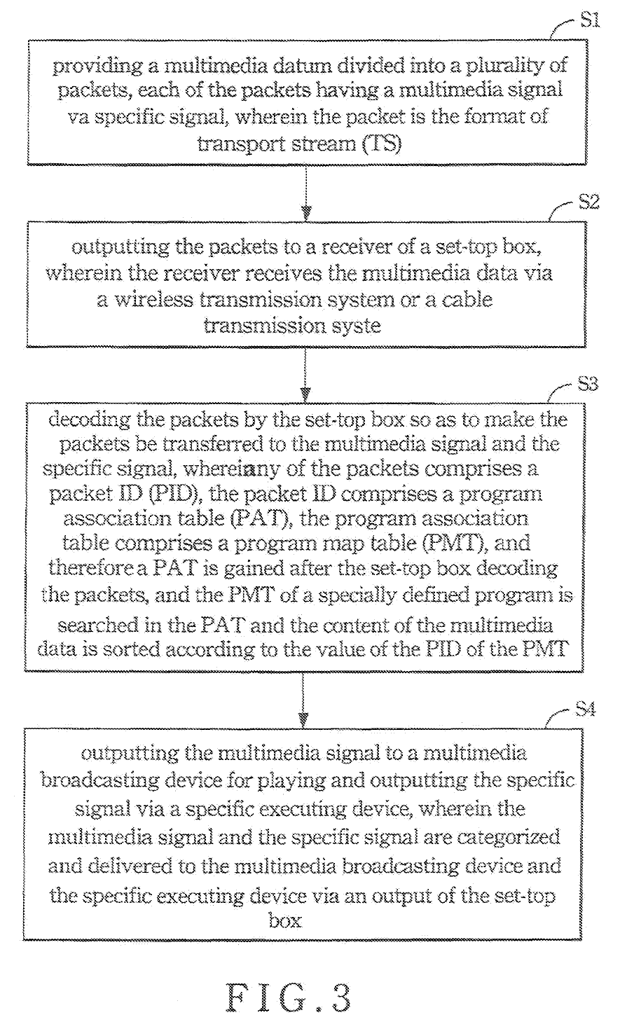

With reference to FIG. 3, which illustrates a flow chart of a method of the present invention. The method for broadcasting multimedia data includes the steps of (S1) providing a multimedia datum divided into a plurality of packets, each of the packets having a multimedia signal and a specific signal, wherein the packet is the format of transport stream (TS); (S2) outputting the packets to a receiver of a set-top box, wherein the receiver receives the multimedia data via a wireless transmission system or a cable transmission system; (S3) decoding the packets by the set-top box so as to make the packets be transferred to the multimedia signal and the specific signal, wherein any of the packets comprises a packet ID (PID), the packet ID comprises a program association table (PAT), the program association table comprises a program map table (PMT), and therefore a PAT is gained after the set-top box decoding the packets, and the PMT of a specially defined program is searched in the PAT and the content of the multimedia data is sorted according to the value of the PID of the PMT; and (S4) outputting the multimedia signal to a multimedia broadcasting device for playing and outputting the specific signal via a specific executing device, wherein the multimedia signal and the specific signal are categorized and delivered to the multimedia broadcasting device and the specific executing device via an output of the set-top box.

With the comparison to the prior system for broadcasting multimedia data, the present invention obviously increases the feelings to entertainment and space.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is

1. A system for broadcasting multimedia data, comprising:
a multimedia data supplier, which divides a multimedia datum into a plurality of packets for output, wherein the packet at least comprises a multimedia signal and a specific signal;
a set-top box having a receiver, a first output and a second output, the receiver being connected to the multimedia data supplier for receiving the packets, the packets being transferred to the multimedia signal and the specific signal after the set-top box decoding the packets, the multimedia signal being output by the first output and the specific signal being output by the second output;
a multimedia broadcasting device, which is connected to the first output and broadcasts the multimedia signal; and
a specific executing device, connected to the second output and produces special effects defined by the specific signal.

2. The system for broadcasting multimedia data according to claim 1, wherein the set-top box is a gateway.

3. The system for broadcasting multimedia data according to claim 1, wherein the receiver receives the multimedia data via a wireless transmission system.

4. The system for broadcasting multimedia data according to claim 1, wherein the receiver receives the multimedia data via a cable transmission system.

5. The system for broadcasting multimedia data according to claim 1, wherein the receiver receives the multimedia data via a content server.

6. The system for broadcasting multimedia data according to claim 1, wherein the multimedia signal is selected from the group consisting of video, audio and service information.

7. The system for broadcasting multimedia data according to claim 1, wherein the packet is the format of transport stream (TS).

8. The system for broadcasting multimedia data according to claim 1, wherein the specific executing device is selected from the group consisting of a sound generator, a light generator, a fluid spray generator, a mechanism-action generator, and a scent generator.

9. The system for broadcasting multimedia data according to claim 1, wherein the packet comprises a packet ID (PID), the packet ID comprises a program association table (PAT), the program association table comprises a program map table (PMT).

10. A method for broadcasting multimedia data, comprising:
providing a multimedia datum divided into a plurality of packets, each of the packets having a multimedia signal and a specific signal;
outputting the packets to a receiver of a set-top box;
decoding the packets by the set-top box so as to make the packets be transferred to the multimedia signal and the specific signal; and
outputting the multimedia signal to a multimedia broadcasting device for playing and outputting the specific signal via a specific executing device.

11. The method for broadcasting multimedia data according to claim 10, wherein the receiver receives the multimedia data via a wireless transmission system.

12. The method for broadcasting multimedia data according to claim 10, wherein the receiver receives the multimedia data via a cable transmission system.

13. The method for broadcasting multimedia data according to claim 10, wherein the packet is the format of transport stream (TS).

14. The method for broadcasting multimedia data according to claim 10, wherein any of the packets comprises a packet ID (PID), the packet ID comprises a program association table (PAT), the program association table comprises a program map table (PMT), and further has the steps of:
a PAT being gained after the set-top box decoding the packets, and the PMT of a specially defined program being searched in the PAT;
sorting the content of the multimedia data according to the value of the PID of the PMT; and
the multimedia signal and the specific signal being categorized and delivered to the multimedia broadcasting device and the specific executing device via an output of the set-top box.
